(19) United States
(12) Patent Application Publication
(10) Pub. No.: US 2007/0295605 A1
(43) Pub. Date: Dec. 27, 2007

(54) Micropump controlled by electrocapillary and gas pressures

(75) Inventors: Su-Moon Park, Kyungsangbuk-do (KR); Woon Kie Paik, Hoffman Estates, IL (US); Sun-Il Mho, Gyeonggi-do (KR); In Hyeong Yeo, Seoul (KR); Yeon O. Kim, Gyeonggi-do (KR)

Correspondence Address: BACON & THOMAS, PLLC, 625 SLATERS LANE, FOURTH FLOOR, ALEXANDRIA, VA, 22314, US

(73) Assignees: POSTECH FOUNDATION, Kyungsangbuk-do (KR); POSTECH ACADEMY-INDUSTRY FOUNDATION, Kyungsangbuk-do (KR)

(21) Appl. No.: 11/475,139

(22) Filed: Jun. 27, 2006

(51) Int. Cl. G01N 27/00

(52) U.S. Cl. 204/601

(57) ABSTRACT

A micropump utilizes electrically controlled interfacial tension between a mercury column and an electrolyte solution in a capillary tube, and also uses the gas pressure in a confined chamber connected to the capillary tube as the restoring pressure. Accordingly, the pump operates without generating external jitter or noise, in vertical, horizontal, or in any orientation against the gravitational force. In this manner, the flow rate of the pumped fluid can be widely and conveniently controlled. Further, the micropump is small in size and simple in construction, and needs extremely small power consumption.

### FIELD OF THE INVENTION

The present invention relates to a micropump for delivering fluid in small amounts; and, more particularly, to a micropump taking advantages of the change in surface tensions at the mercury/aqueous electrolyte interfaces caused by periodically changing potentials between two preset values.

### BACKGROUND OF THE INVENTION

Reliable and reproducible micropumps have been in demands for continuous delivery of drugs or other biologically active substances, continuous operation of micro total analysis systems (pTAS) such as the lab-on-a-chip as well as other microanalysis apparatuses, continuous injection of reactants in a reaction vessel such as in miniaturized fuel cell systems, printer heads, and active cooling of microelectronics.

Technologies including piezoelectric devices and those utilizing electrocapillary effects and reversible electrochemical gas evolution-dissolution reactions have been employed to construct micropumps. However, no satisfactory micropumps have been constructed thus far, which meet the technical specifications necessary for operation of the above demands.

Of these, the micropump employing electrocapillary effects takes advantages of the changes in surface tensions of the mercury/electrolyte interfaces. Micropumps constructed and patented thus far, however, used the perpendicular movement of mercury column by the electrocapillary effect, which returns back to its original position by the gravitational force. For this reason, the mercury column had to be oriented perpendicular to the surface of the earth; relatively voluminous uses of mercury may result in its spill causing environmental problems.

### SUMMARY OF THE INVENTION

It is, therefore, an object of the present invention to provide a micropump to pump fluids, such as liquids or gases, by taking advantage of the electrocapillary effect due to the changes in surface tension at the mercury/electrolyte solution interface and by arranging the component tubes appropriately. Hence the pump can be operated independent of its spatial orientation without having to worry about the gravity effect.

In accordance with the present invention, there is provided a micropump for a controlled flow of a fluid in a designated spatial orientation. The micropump includes: a capillary tube for holding a liquid column and an electrolyte solution, the electrolyte solution forming an interfacial boundary with the liquid column; an electrode installed in the electrolyte solution; a metal pin connected to the liquid column; a voltage source connected to the electrode and the metal pin, to thereby periodically change an interfacial tension between the liquid column and the electrolyte solution, resulting in bidirectional movement of the liquid column; a chamber containing a volume of gas therein and connected to one end of the capillary tube, to provide a restoring force due to an interfacial tension between the gas and the liquid column; a membrane confining the electrolyte solution and separating the electrolyte solution from the fluid; and a fluid transport tube, connected perpendicular to another end of the capillary tube, through which the fluid is pumped by periodically changing potentials due to the bidirectional movement of the electrolyte solution.

### BRIEF DESCRIPTION OF THE DRAWINGS

The above and other objectives and features of the present invention will become apparent from the following description of preferred embodiments, given in conjunction with the accompanying drawings, in which:

FIG. 1 is a schematic of a micropump utilizing electrocapillary effects and the gas pressures as a restoring force in accordance with a preferred embodiment of the present invention;

FIG. 2A shows a micropump engraved channel and space necessary for a gas chamber, an electrolyte solution and a fluid transport tube on a polymer plate in accordance with another embodiment of the present invention;

FIG. 2B is a perspective view with a plunger exploded from the micropump of FIG. 2A;

FIG. 3 shows a micropump including neck portions and a liquid layer membrane that is immiscible with an electrolyte solution as well as with the pumped fluid in accordance with still another embodiment of the present invention;

FIG. 4 represents a micropump array including multiple capillary tubes in accordance with still another embodiment of the present invention; and

FIG. 5 shows a central part of a U-shaped micropump based on gravitational restoring force in accordance with still another embodiment of the present invention.

### DETAILED DESCRIPTION OF THE PREFERRED EMBODIMENTS

Hereinafter, preferred embodiments of the present invention will be described in detail with reference to the accompanying drawings.

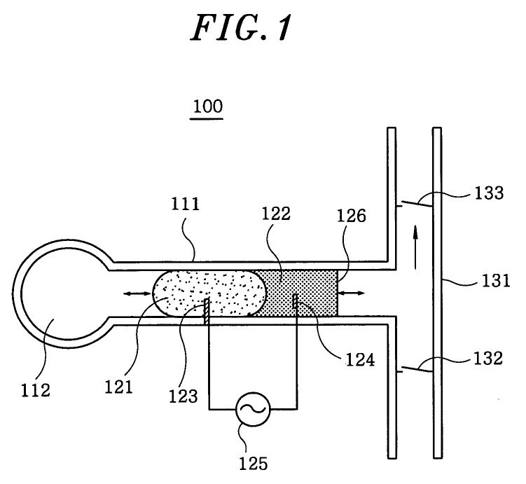

As shown in FIG. 1, a micropump 100 includes a gas chamber 112 of a given volume; a capillary tube 111 connected to the gas chamber 112; a fluid transport tube 131, connected perpendicular to the capillary tube 111, through which a fluid such as a liquid or a gas to be pumped moves; two check valves 132, 133 that control the flow of the fluid within the fluid transport tube 131; a metal pin 123 connected to a liquid column (e.g., mercury column) 121; an electrolyte solution 122 forming an interfacial boundary with the mercury column 121; an electrode 124 immersed in the electrolyte solution 122; a membrane 126 that confines the electrolyte solution 122 within the capillary tube 111, and separates the electrolyte solution 122 from the fluid; and a voltage source 125 connected to the metal pin 123 and the electrode 124.

The gas chamber 112, which is filled with dry air, nitrogen, inert gas, or the like, is connected to one side of the capillary tube 111. The capillary tube 111 may be constructed with a glass or engraved into a solid polymeric material. The capillary tube 111 is filled with an appropriate amount of mercury column 121 and is provided with the metal pin 123.

Since mercury is hydrophobic and has a large surface tension, the mercury column 121 forms convex meniscuses on its both sides. It is desirable to use platinum or any other metal for the metal pin 123, which does not dissolve in mercury to form an amalgam. The gas chamber 112 is isolated from the ambient air because of the mercury column 121 filled in the center of the capillary tube 111. Instead of mercury, any liquid that does not mix or react with the electrolyte solution 122 may be used. However, an appropriate amount of salt need be added to make it electrically conductive in case that the liquid itself is non-conductive.

The other side of the capillary tube 111 is filled with an electrolyte solution 122, which does not react or mix with mercury column 121. To separate the electrolyte solution 122 from the fluids being pumped, a membrane 126 is used. For the electrolyte solution 122, an aqueous solution containing a salt, an acid, or a base can be used. The aqueous solution is inert to the electrochemical reaction within the employed potential range. The electrolyte solution 122 is required to be electrically conductive, and an electric double layer is formed at the interface between the mercury column 121 and the electrolyte solution 122. The electrode 124 is installed around the middle of the electrolyte solution 122, and may be formed of a bare silver wire or preferably a silver wire coated with silver chloride formed by chlorination of the silver wire surface. In order to maintain a constant potential at the electrode 124, an appropriate amount of chloride may be added to the electrolyte solution 122. Alternatively, another acid or base solution may be added for maintaining a constant potential at the electrode 124.

The fluid transport tube 131 transporting the fluid to be pumped is connected perpendicular to the capillary tube 111 on the opposite side of the gas chamber 112. Within this fluid transport tube 131, two check valves 132 and 133 are provided so that the fluid would flow in a designated direction only. In this connection, the capillary tube 111 is connected to the fluid transport tube 131 at a location between two check valves 132 and 133.

The metal pin 123 disposed within the mercury column 121 and the electrode 124 immersed in the electrolyte solution 122 are connected to the voltage source 125. The voltage source 125 provides square or sine wave voltages to the system through the metal pin 123 and the electrode 124.

The operation of micropump 100 will now be explained.

The surface tension (or interfacial tension) between a mercury and an electrolyte solution becomes maximum at a certain potential (potential of zero charge (PZC)) of the mercury relative to the electrolyte solution, and then, diminishes sharply as the potential is made higher or lower than PZC (electrocapillary phenomenon). The surface tension of the mercury column exerts a pressure toward the inside thereof. Referring to Eq. 1, this surface pressure P is proportional to the surface tension γ and is inversely proportional to the radius r of the capillary tube containing the mercury column:

P=2γ/r Eq. 1.

The surface pressure can, therefore, be changed by the applied potential, and hence the mercury column can be easily pushed or pulled by manipulating the applied potential. The reciprocal movement thus generated is the core mechanism of the micropump in the present invention as the piston in a cylinder.

The fluid to be pumped stays still before a square or sine wave is applied, as both the check valves 132, 133 are closed. In order to operate the micropump 100, a square or sine wave voltage is applied to the metal pin 123 and the electrode 124 by turning on the voltage source 125, resulting in a periodic change in surface tension of the mercury column 121 in the capillary tube 111. Due to the periodic change, the mercury column 121 moves back and forth along the axis of the capillary tube 111 at the frequency of the square or sine wave voltage.

When the mercury column 121 moves towards the gas chamber 112, the electrolyte solution 122 also moves towards the gas chamber 112, thereby pulling the fluid and thus opening the check valve 132 while closing the check valve 133. When the mercury column 121 moves in the opposite direction, the check valve 132 closes and the check valve 133 opens up due to the pressure built up in the fluid transport tube 131. Repeated operations using the square or sine wave allow the fluid to be pumped effectively between the two check valves 132 and 133 of the fluid transport tube 131.

The bidirectional movement of the mercury column 121 causes the fluid transport tube 131 to be sucked in or out depending on the position of the flexible membrane 126 confining the electrolyte solution 122. The position of the membrane 126 changes in unison with that of the interface between the mercury column 121 and the electrolyte solution 122. As a result, the fluid in the fluid transport tube 131 is controlled to be moved towards one direction by the two check valves 132 and 133.

Meanwhile, the operating of the voltage source 125 can be a square or sinusoidal wave of a relatively low frequency and a small magnitude, typically about 0.5 V peak-to-peak, which may be directly applied to the metal pin 123 and the electrode 124, overlaid on the open circuit voltage or a given DC (direct current) voltage. An appropriate range of voltage levels and the frequency can be determined depending on the desired rate and the amount of the fluid to be pumped, the types of the solvent and salt used in the electrolyte solution 122, etc. The optimum bias DC voltage can be determined such that the potential of zero charge (PZC) is located one side of the potential range of the square or sinusoidal wave. If the signal has too high frequency, the rapid movement of the mercury column 121 may generate small mechanical waves on its surfaces, which may cause unwanted creeping of the electrolyte solution 122 between the mercury column 121 and the wall of the capillary tube 111.

When the gas in the gas chamber 112 is compressed due to the movement of the mercury column 121 towards the gas chamber 112, the compressed gas pushes it back to release the pressure. This, along with the change in surface tension, leads to the periodic movement of the mercury column 121, resulting in an effective operation of the micropump 100. This feature, which is different from the other prior art pumps, allows the micropump 100 to be used in any situation regardless of the orientation. When the micropump 100 has to be spatially oriented such that the mercury column 121 would move along the axis of gravity, its pumping can be adjusted by controlling the volume of the gas chamber 112.

The micropump 100 thus formed operates without the effect of the gravitational force in all possible orientations independent of how the micropump 100 is situated in space. Further, the micropump 100 needs no electrical motor, consumes a very small amount of electrical energy, and is simple in its mechanical structure.

Hereinafter, another preferred embodiment of the present invention will be explained.

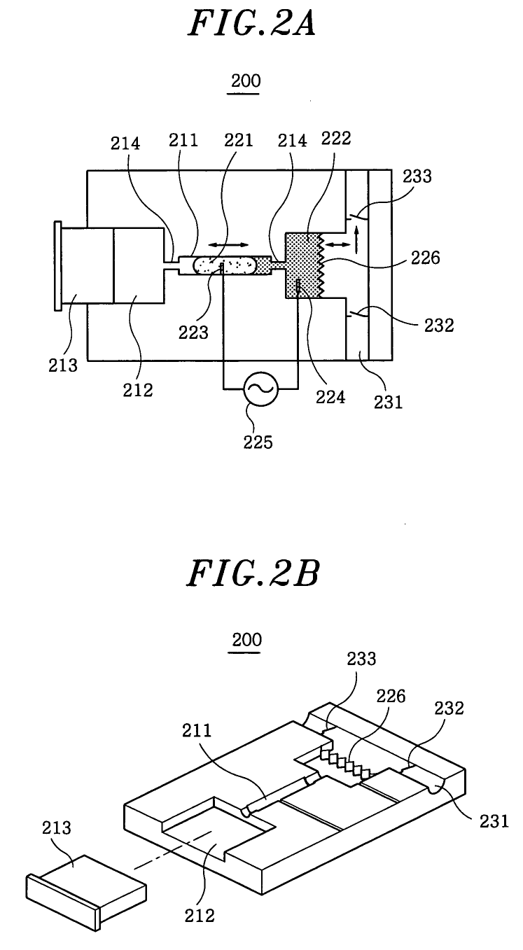

As shown in FIGS. 2A and 2B, a micropump 200 includes a gas chamber 212 of a given volume; a capillary tube 211 connected to the gas chamber 212; a fluid transport tube 231 through which a pumped fluid is moved and connected perpendicular to the capillary tube 211; two check valves 232, 233 for controlling the flow of the fluid; a metal pin 223 disposed within the mercury column 221; an electrolyte solution 222 forming an interfacial boundary with the mercury column 221; an electrode 224 immersed in the electrolyte solution 222; a membrane 226 that confines the electrolyte solution 222 within the capillary tube 211, and separates the electrolyte solution 222 from the fluid; and a voltage source 225 connected to the metal pin 223 and the electrode 224.

And, the micropump 200 may further include a pair of neck portions 214 provided on both sides of the capillary tube 211 to confine the mercury column 221 at a portion of the capillary tube 211 between the neck portions 214; and a plunger 213 fitted in the gas chamber 212 for adjusting the volume of the gas chamber 212.

Instead of the fixed volume gas chamber 112 (FIG. 1), the plunger 213 is fitted into the gas chamber 212, thereby enabling convenient adjustment of the gas volume. An elastic thimble may also be used instead of the plunger 213.

The membrane 226 may be formed of expandable/contractible solid material in any shape.

Also, the neck portions 214, of which diameters are slightly smaller than those of the capillary tube 211, is provided on both sides of the mercury column 221 to prevent mercury column 221 from flowing into the gas chamber 212 and/or the fluid transport tube 231 in a case of an unexpected mechanical shock.

The micropump 200 may be formed in small polymer blocks as shown in FIGS. 2A and 2B. Upper and lower parts with engraved grooves correspond to the capillary tube 211, the gas chamber 212 and the transport tube 231. The parts can be fabricated on polymer blocks by means of a lithographic technique. The micropump 200 may be further formed by overlaying the top part over the bottom part. Variations in components are also possible.

The operation of the micropump 200 is substantially identical to that of the micropump 100, and therefore, will be omitted for the simplicity.

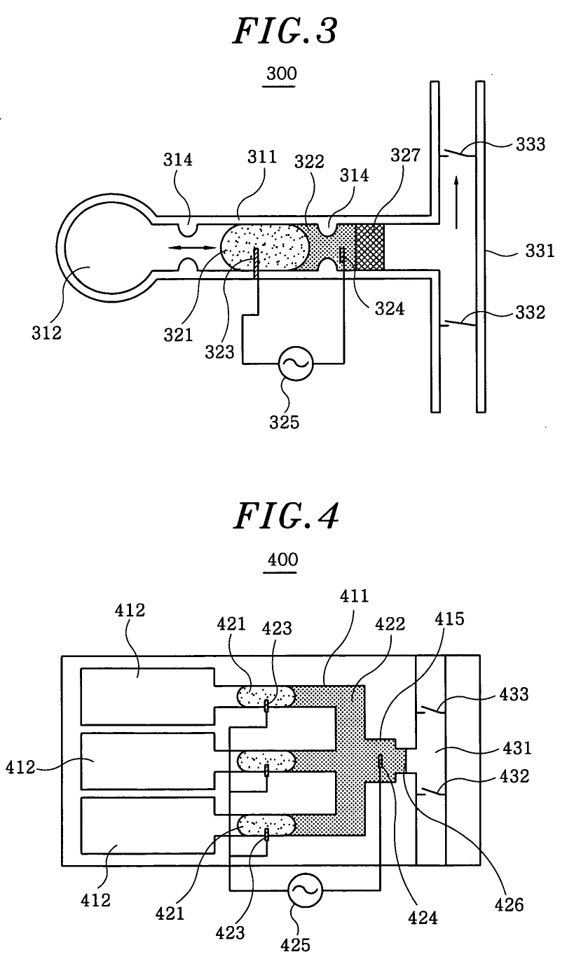

FIG. 3 shows a micropump in accordance with still another embodiment of the present invention.

A micropump 300 includes a gas chamber 312 of a given volume; a capillary tube 311 connected to the gas chamber 312; a fluid transport tube 331 through which a pumped fluid moves connected perpendicular to the capillary tube 311; two check valves 332, 333 for controlling the flow of the fluid disposed on both sides of the fluid transport tube 231; a metal pin 323 disposed within the mercury column 321; an electrolyte solution 322 forming an interfacial boundary with the mercury column 321; an electrode 324 immersed in the electrolyte solution 322; and a voltage source 325 connected to the metal pin 323 and the electrode 324.

Further, the micropump 300 includes neck portions 314 provided on both sides of the capillary tube 311 to confine the mercury column 321 at a portion of the capillary tube 311 between the neck portions 314; and a membrane 327 for confining the electrolyte solution 322 within the capillary tube 311, and for separating the electrolyte solution 322 from the fluid.

The membrane 327 is formed of, e.g., a liquid paraffin layer. The membrane 327 is immiscible with the fluid being pumped and the electrolyte solution 322. The expandable/contractible membranes such as shown in FIGS. 1, 2A, and 2B can also be used in this aspect instead.

FIG. 4 shows a micropump array in accordance with still another embodiment of the present invention.

A micropump arrays 400 includes a plurality of capiliary tubes 411; a centralized chamber 415 into which the capiliary tubes 411 are merged; a plurality of mercury columns 421 located within the respective capillary tubes 411; an electrolyte solution 422 in the capillary tubes 411 and the centralized chamber 415; a plurality of metal pins 423 disposed within the respective mercury columns 421; an electrode 424 disposed within the centralized chamber 415; a voltage source 425 connected to the metal pins 423 and the electrode 424, for supplying square waves or alternating voltages; a plurality of gas chambers 412 connected to the respective capillary tubes 411; a fluid transport tube 431, connected perpendicular to the chamber 415, through which the fluid to be pumped; a pair of check valves 432, 433 provided inside the fluid transport tube 431, for guiding the pumped fluid in a designated direction while preventing backflow of the pumped fluid; and a membrane 426 separating the electrolyte solution 422 from the fluid.

The micropump 400 can also equipped a plurality of plungers (not shown) for adjusting the volumes of the corresponding gas chambers 412; and neck portions (not shown), whose diameters are smaller than those of the capillary tubes 411, provided on both sides of the mercury columns 421.

By means of connecting the capillary tubes 411 in parallel and merging them into the chamber 415, the pumping capacity per unit time increases.

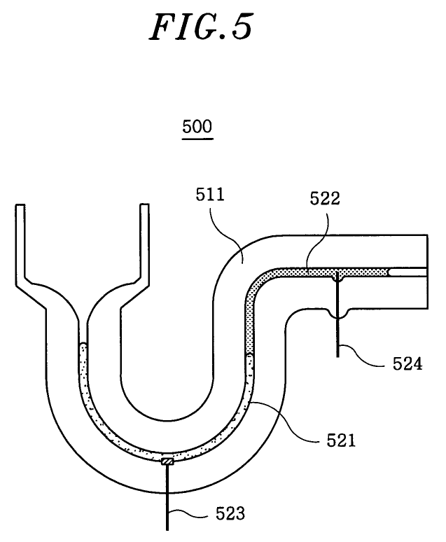

Meanwhile, based on gravitational restoring force against the electrocapillary tension as seen in FIG. 5, still another preferred embodiment of the present invention will be explained.

A micropump 500 includes a U-shaped capillary tube 511 containing a mercury column 521 and an electrolyte solution 522; an electrode 524 disposed to contact the electrolyte solution 522; and a metal pin 523 disposed to contact the mercury column 521.

The micropump 500 further include a voltage source (not shown) connected to the electrode 524 and the metal pin 523, for supplying square waves or alternating voltages; a fluid transport tube (not shown), connected perpendicular to the capillary tube 511, through which the fluid to be pumped; and a pair of check valves (not shown) provided to the fluid transport tube, for guiding the pumped fluid in designated direction while preventing backflow of the pumped fluid.

In this case, the mercury column 521 moves by the changes in surface tension, and the electrically initiated movement is restored due to the gravitational force. While this configuration allows only a given spatial orientation, more efficient design may be used.

While two experiments for the construction and operation of the micropumps will be given below to demonstrate how effectively they work, their applications are not limited by what are shown by the two examples.

### EXAMPLE 1

The pumping rate (flow rate) of the micropump is determined by the moving rate of the mercury column and the cross sectional area of the capillary tube. The moving rate is determined by the distance of the mercury column movement multiplied by the frequency of the square or AC waves applied. The maximum pumping rate is then expressed by Eq. 2:

Pumping rate=d·f·A Eq. 2,

where d is the distance of the mercury column movement, f is the frequency of the AC or square pulse wave, and A is the cross sectional area of the capillary tube. The pumping rate may be adjusted by controlling any of these parameters.

When the change in surface tension of mercury was 5%, which was usually achievable with a half volt amplitude, the gas volume was 1.0 cm³, the radius of the capillary tube was 0.5 mm, and the frequency of the square or AC waves was 1 Hz, the pumped volume per one cycle was 0.79 μL/s at an atmospheric pressure of the gas and the distance of the mercury column movement of 1 mm, and the pumping rate was 47 μL/min. When the length of the mercury column is to be 2 mm, the amount of the mercury column to be used is 0.0016 cm³, or 21 mg.

### EXAMPLE 2

The same conditions were adapted as those in EXAMPLE 1 except that the gas volume was 0.1 cm³ and the radius of the capillary tube was 0.1 mm, the pumped volume per one cycle was 0.4 μL/s, the distance of the mercury column movement was 13 mm, and the pumping rate was 24 μL/min. When the length of the mercury column is to be 2 mm, the amount of the mercury column to be used is 0.000063 cm³, or 0.85 mg.

In summary, the micropump described in the present invention has the following characteristics: (1) a very small amount of liquids or gases can be pumped, (2) the size of the pump is small with its simple structure and the low construction cost, (3) the pump can be used to pump a wide variety of fluids including aqueous solution, nonaqueous solution, gases or the like, (4) no vibration and/or no noise is generated during its operation, (5) the flow and pumping rates can be easily controlled, (6) the pump can be arranged in any spatial orientation, (7) the pump may be applied to microanalysis, mixing/dividing fluids for chemical reactions, or any other purposes, (8) no significant consumption of energy due to the lack of frictional forces or other mechanical stresses, resulting in low consumption of the power and small operational variations due to the temperature changes, and (9) very low pollution or damages of the environment are expected due to mercury spills, if any, thanks to a very small amount of mercury used in a closed space.

While the invention has been shown and described with respect to the preferred embodiments, it will be understood by those skilled in the art that various changes and modification may be made without departing from the scope of the invention as defined in the following claims.

What is claimed is:

1. A micropump for a controlled flow of a fluid in a designated spatial orientation, comprising:
a capillary tube for holding a liquid column and an electrolyte solution, the electrolyte solution forming an interfacial boundary with the liquid column;
an electrode installed in the electrolyte solution;
a metal pin connected to the liquid column;
a voltage source connected to the electrode and the metal pin, to thereby periodically change an interfacial tension between the liquid column and the electrolyte solution, resulting in bidirectional movement of the liquid column;
a chamber containing a volume of gas therein and connected to one end of the capillary tube, to provide a restoring force due to an interfacial tension between the gas and the liquid column; and
a fluid transport tube, connected perpendicular to another end of the capillary tube, through which the fluid is pumped by periodically changing potentials due to the bidirectional movement of the electrolyte solution.

2. The micropump of claim 1, further comprising a plunger for changing the volume of the chamber.

3. The micropump of claim 1, further comprising at least two check valves installed in the transport tube for guiding the pumped fluid in a designated direction while preventing backflow of the pumped fluid,
wherein the capillary tube is connected to the fluid transport tube at a location between the check valves.

4. The micropump of claim 1, wherein the capillary tube includes:
one or more neck portions, formed along inner peripheries of the capillary tube and distanced from both sides of the liquid column, for preventing the liquid column to be spilled into the chamber.

5. The micropump of claim 1, further comprising a membrane for confining the electrolyte solution and separating the electrolyte solution from the fluid, wherein the membrane includes an expandable/contractible solid material and/or a liquid paraffin layer.

6. A micropump array for a controlled flow of a fluid in a designated spatial orientation, comprising:
a plurality of capillary tubes, each tube having a liquid column and an electrolyte solution, wherein the electrolyte solutions form interfacial boundaries with the liquid columns respectively;
a plurality of metal pins, each metal pin being disposed in parallel within its corresponding liquid column;
an electrode installed in the electrolyte solution;
a voltage source connected to the electrodes and the metal pins, to thereby periodically change interfacial tensions between the liquid columns and the electrolyte solutions, resulting in bidirectional movements of the liquid columns and the electrolyte solutions;
a plurality of chambers, each chamber containing a gas and being connected to its corresponding capillary tube, to thereby provide restoring forces due to interfacial tensions between the gases and the liquid columns; and
a fluid transport tube, connected perpendicular to the capillary tubes and communicated with the capillary tubes, through which the fluid is pumped by periodically changing potentials due to the bidirectional movement of the electrolyte solutions.

7. The micropump array of claim 6, further comprising a plurality of plungers for changing the volumes of the respective chambers, to thereby adjust the volumes of the gases.

8. The micropump array of claim 6, further comprising at least two check valves installed in the fluid transport tube at a distance with each other for guiding the pumped fluid in a designated direction while preventing a backflow of the pumped fluid, wherein one ends of the fluid transport tube are merged to the centralized chamber at a location between the check valves.

9. The micropump array of claim 6, wherein the capillary tube includes:
one or more neck portions, formed along inner peripheries of the capillary tube and distanced from both sides of the liquid column, for preventing the liquid column to be spilled into the chamber.

10. The micropump array of claim 6, further comprising a membrane for confining the electrolyte solution and separating the electrolyte solution from the fluid, wherein the membrane includes an expandable/contractible solid material and/or a liquid paraffin layer.

11. A micropump for gravitational restoring force against the pressure from the electrocapillary tension, comprising:
a U-shaped capillary tube containing a mercury column and an electrolyte solution;
an electrode immersed in the electrolyte solution;
a metal pin disposed to contact the mercury column;
a voltage source connected to the electrode and the metal pin, to thereby periodically change an interfacial tension between the liquid column and the electrolyte solution, resulting in bidirectional movements of the liquid column and the electrolyte solution;
a membrane confining the electrolyte solution and separating the electrolyte solution from the fluid; and
a fluid transport tube, connected perpendicular to the end of the capillary tube, through which the fluid to be pumped by periodically changing potentials due to the bidirectional movement of the electrolyte solution.

12. The micropump of claim 11, further comprising at least two check valves, for guiding the pumped fluid in a designated direction while preventing a backflow of the pumped fluid, wherein the capillary tube is connected to the fluid transport tube at a location between the check valves.
